(19) United States
(12) Patent Application Publication
(10) Pub. No.: US 2026/0178840 A1
(43) Pub. Date: Jun. 25, 2026

(54) SERVER FOR ANALYZING USER QUERIES AND ASSISTING COUNSELORS IN COUNSELING SERVICES USING LLM AND METHOD FOR OPERATION THEREOF

(71) Applicant: Yanolja NEXT Co., Ltd., Seoul (KR)

(72) Inventors: Seungduk KIM, Seoul (KR); Seungtaek CHOI, Seoul (KR)

(73) Assignee: Yanolja NEXT Co., Ltd., Seoul (KR)

(21) Appl. No.: 19/388,421

(22) Filed: Nov. 13, 2025

(30) Foreign Application Priority Data
Dec. 24, 2024 (KR) 10-2024-0194841

(51) Int. Cl. G06F 40/35; G06F 40/40

(52) U.S. Cl. CPC G06F 40/35; G06F 40/40

(57) ABSTRACT

According to various embodiments, a server for analyzing a user's query and assisting counseling service of a counselor using a Large Language Model (LLM) includes a communication module and a processor. The processor is configured to identify input text data related to the user's query, input the input text data into a first LLM to identify user's intent information and guide information corresponding to the input text data, and input the user's intent information, the guide information, and information on a reaction to the guide information into a second LLM to identify answer text data with respect to the input text data. The first LLM is trained based on a plurality of input text data, a plurality of user's intent information, and a plurality of reaction information, and the second LLM is trained based on input text data, user's intent information, guide information, reaction information, and answer text data.

### CROSS-REFERENCE TO RELATED APPLICATION

This application claims priority to and the benefit of Korean Patent Application No. 10-2024-0194841, filed on Dec. 24, 2024, the disclosure of which is incorporated herein by reference in its entirety.

### BACKGROUND

### 1. Field of the Invention

Various embodiments of the present disclosure relate to a server for analyzing user queries and assisting counselors in counseling services using LLM, and a method for operation thereof.

### 2. Discussion of Related Art

Recently, artificial intelligence systems implementing human-level intelligence are being used in various fields. Unlike existing rule-based smart systems, artificial intelligence systems are systems where machines learn, judge, and become smarter on their own. As artificial intelligence systems are used more, their recognition rate improves and they can understand user preferences more accurately, gradually replacing existing rule-based smart systems with deep learning-based artificial intelligence systems.

Artificial intelligence technology consists of machine learning (e.g., deep learning) and element technologies utilizing machine learning. Machine learning is an algorithm technology that classifies/learns the features of input data on its own, and element technology is a technology that mimics functions such as cognition and judgment of the human brain using machine learning algorithms like deep learning, consisting of technical fields such as linguistic understanding, visual understanding, inference/prediction, knowledge representation, and motion control.

Meanwhile, Large Language Models (LLM) are a type of artificial intelligence trained on large collections of text data to generate human-like responses to natural language input. They are language models composed of artificial neural networks possessing numerous parameters (usually billions of weights or more). Such LLMs can be trained with substantial amounts of text using self-supervised learning or semi-supervised learning.

### SUMMARY OF THE INVENTION

Various embodiments of the present disclosure may provide a method for counselors performing counseling tasks in various fields to quickly respond with solutions to user queries without unnecessary emotional exchange with the user.

Various embodiments of the present disclosure may provide a method for learning the counselor's response process to user queries through an LLM, and reflecting user feedback on the counselor's response process into the LLM to enhance and optimize the performance of the LLM.

According to various embodiments, a server for analyzing a user's query and assisting counseling service of a counselor using an LLM includes a communication module and a processor. The processor is configured to identify input text data related to the user's query, input the input text data into a first Large Language Model (LLM) to identify user's intent information and guide information corresponding to the input text data, and input the user's intent information, the guide information, and information on a reaction to the guide information into a second LLM to identify answer text data with respect to the input text data, wherein the first LLM is trained based on a plurality of input text data, a plurality of user's intent information, and a plurality of reaction information, and the second LLM is trained based on one or more input text data, one or more user's intent information, one or more guide information, one or more reaction information, and one or more answer text data.

According to various embodiments, an operation method of a server for analyzing a user's query and assisting counseling service of a counselor using an LLM includes: an operation of identifying input text data related to the user's query; an operation of inputting the input text data into a first Large Language Model (LLM) to identify user's intent information and guide information corresponding to the input text data; and an operation of inputting the user's intent information, the guide information, and information on a reaction to the guide information into a second LLM to identify answer text data with respect to the input text data, wherein the first LLM is trained based on a plurality of input text data, a plurality of user's intent information, and a plurality of reaction information, and the second LLM is trained based on one or more input text data, one or more user's intent information, one or more guide information, one or more reaction information, and one or more answer text data.

The present disclosure can provide the effect of improving convenience for both counselors and users by analyzing user queries using an LLM while generating optimal guide information and answer text information for responding to user queries.

### BRIEF DESCRIPTION OF THE DRAWINGS

FIG. 1 is a block diagram showing a user device and a server according to various embodiments of the present disclosure.

FIG. 2 is a view showing a method of communicating between a user and a counselor using a counseling assistance service provided by the server of the present disclosure according to various embodiments.

FIG. 3 is a flowchart illustrating an operation of generating answer text data with respect to a user's query using an LLM by the server according to various embodiments.

FIG. 4A is a view showing a first embodiment of generating answer text data with respect to a user's query by the server using a first LLM and a second LLM according to various embodiments.

FIG. 4B is a view showing a second embodiment of generating answer text data with respect to a user's query by the server using a first LLM and a second LLM according to various embodiments.

FIG. 5 is a view showing the configuration of a screen used when a counselor device performs counseling using a user device and a counseling assistance service according to various embodiments.

FIG. 6 is an exemplary view showing a method of operating a first LLM trained to output guide information according to various embodiments.

### DETAILED DESCRIPTION OF THE PREFERRED EMBODIMENT

Hereinafter, various embodiments of the present document will be described with reference to the accompanying drawings. It should be understood that the embodiments and the terms used herein are not intended to limit the techniques described in this document to a specific embodiment, but to include various modifications, equivalents, and/or substitutes of the embodiments. In relation with the description of the drawings, similar reference numerals may be used for similar Singular expressions may include plural expressions unless the context clearly components. indicates otherwise. In this document, expressions such as “A or B”, “at least one among A and/or B”, and the like may include all possible combinations of the items listed together. Expressions such as “a first”, “a second”, “first”, “second”, and the like may modify corresponding components regardless of the order or importance, and are used only to distinguish one component from another and do not limit corresponding components. When it is said that a certain (e.g., a first) component is “(functionally or communicatively) connected” or “coupled” to another (e.g., a second) component, the certain component may be directly connected to another component, or may be connected through still another component (e.g., a third component).

In this document, an expression such as “configured (set) to” may be used to be interchanged with, for example, “suitable for”, “having an ability of”, “modified to”, “made to”, “capable of”, or “designed to” in hardware or software according to a situation. In a certain situation, an expression such as “a device configured to” may mean that the device is “capable of” doing something together with other devices or components. For example, an expression such as “a processor configured (set) to perform A, B, and C” may mean a dedicated processor (e.g., an embedded processor) for performing a corresponding operation or a general-purpose processor (e.g., a CPU or application processor) that may perform a corresponding operation by executing one or more software programs stored in a memory device.

A user device or an electronic device according to various embodiments of the present document may include, for example, at least one among a smartphone, a tablet PC, a desktop PC, a laptop PC, a netbook computer, a workstation, and a server.

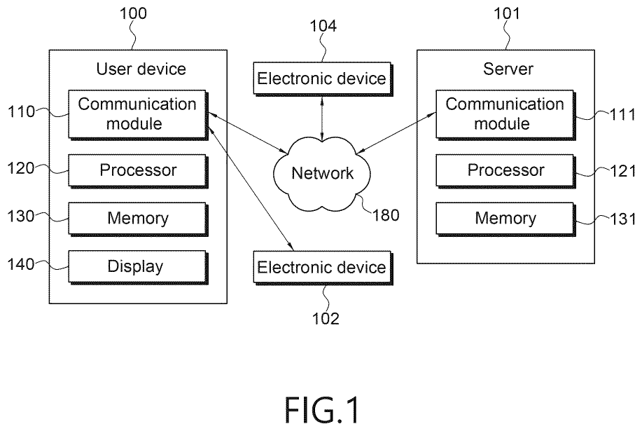

Referring to FIG. 1, a user device 100 and a server 101 are described in various embodiments. The user device 100 may include a communication module 110, a processor 120, a memory 130, and a display 140. In some embodiments, the user device 100 may omit at least one of the components or additionally include other components.

The communication module 110 may set communication between, for example, the user device 100 and an external device (e.g., a first external electronic device 102, a second external electronic device 104, or the server 101). For example, the communication module 110 may be connected to a network 180 through wireless communication or wired communication to communicate with the external device (e.g., the second external electronic device 104 or the server 101).

The wireless communication may include, for example, cellular communication using at least one among LTE, LTE Advance (LTE-A), code division multiple access (CDMA), wideband CDMA (WCDMA), universal mobile telecommunications system (UMTS), Wireless Broadband (WiBro), and Global System for Mobile Communications (GSM). According to an embodiment, the wireless communication may include, for example, at least one among wireless fidelity (WiFi), Bluetooth, Bluetooth low energy (BLE), Zigbee, near field communication (NFC), Magnetic Secure Transmission, radio frequency (RF), and body area network (BAN). According to an embodiment, the wireless communication may include GNSS. The GNSS may be, for example, Global Positioning System (GPS), Global Navigation Satellite System (Glonass), Beidou Navigation Satellite System (hereinafter “Beidou”), Galileo, or the European global satellite-based navigation system. Hereinafter, in this document, “GPS” may be used interchangeably with “GNSS”. The wired communication may include at least one among, for example, a universal serial bus (USB), a high-definition multimedia interface (HDMI), a recommended standard232 (RS-232), a power line communication, and a plain old telephone service (POTS). The network 180 may include a telecommunications network, for example, at least one among a computer network (e.g., LAN or WAN), the Internet, and a telephone network.

The processor 120 may include one or more among a central processing unit, an application processor, or a communication processor (CP). The processor 120 may, for example, perform operations or data processing related to control and/or communication of at least one other component of the user device 100.

The memory 130 may include volatile and/or nonvolatile memory. The memory 130 may store, for example, commands or data related to at least one other component of the user device 100.

The display 140 may include, for example, a liquid crystal display (LCD), a light emitting diode (LED) display, an organic light emitting diode (OLED) display, a micro electro mechanical systems (MEMS) display, and an electronic paper display. The display 140 may display, for example, various contents (e.g., text, images, videos, icons, and/or symbols) to a user. The display 160 may include a touch screen and receive a touch, gesture, proximity, or hovering input using, for example, an electronic pen or a part of the user's body.

Each of the first and second external electronic devices 102 and 104 may be a type the same as or different from that of the user device 100. According to various embodiments, all or part of operations executed in the user device 100 may be executed in another one or more electronic devices (e.g., the electronic devices 102 and 104 or the server 101. According to an embodiment, when the user device 100 performs a certain function or service automatically or in response to a request, the user device 100 may request other devices (e.g., the electronic device 102 or 104 or the server 101) to perform at least some functions related thereto instead of executing the function or service by itself or additionally. Other electronic device (e.g., the electronic device 102 or 104 or the server 101) may execute the requested function or additional functions and transmit a result thereof to the user device 100. The user device 100 may provide the requested function or service by processing the received result as is or additionally. For this purpose, for example, cloud computing, distributed computing, or client-server computing techniques may be used.

The server 101 may include a communication module 111, a processor 121, and a memory 131. In some embodiments, the server 101 may omit at least one of the components or additionally include other components. The communication module 111, the processor 121, and the memory 131 may perform functions the same as those of the communication module 110, the processor 120, and the memory 130 in the user device 100, respectively.

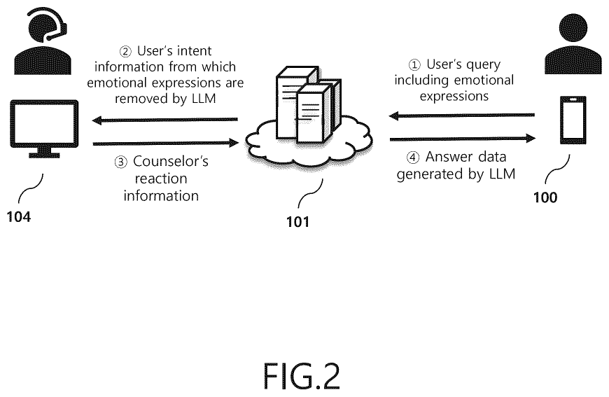

FIG. 2 is a view showing a method of communicating between a user and a counselor using a counseling assistance service provided by the server 101 of the present disclosure according to various embodiments.

According to various embodiments, the server 101 (e.g., a counseling assistance service providing server) may operate an application that allows a user and a counselor to communicate, communicate with user devices (e.g., electronic devices 100, 102, and 104 of FIG. 1) (e.g., a PC, a laptop computer, a smartphone, etc.) through a network 162 or 164, process a request received from the user device 100 or 104 through a messenger application or a web page, and transmit requested information to the user device 100 or 104. According to an embodiment, the server 101 and the electronic device 104 may include the same types of components as the components of the electronic device 100 of FIG. 1.

A user device (e.g., the user device 100 of FIG. 1) according to the present disclosure may request counseling of a counselor through a specific application, and the counselor device 104 may accept communication connection with the user device 100.

According to an embodiment, after the communication connection between the counselor device 104 and the user device 100 is established, the user device 100 may acquire user's voice data from the user and transmit it to the server 101. The server 101 may convert the user's voice data received from the user device 100 into text data using a Speech-to-Text (STT) module. When the user's voice data is converted into text data and transmitted as is to the counselor device 104, and the text data includes expressions that may hurt the feeling of the counselor, it needs to process the user's query after removing these expressions. The server 101 according to the present disclosure may identify data (e.g., at least one among the user's intent information, context information, and guide information), which is obtained by removing emotional expressions from the input text data related to the user's query, using the first LLM, and transmit the identified data to the counselor device 104. According to an embodiment, the first LLM may be trained to rewrite the input text data into text data excluding emotional expressions therefrom.

According to an embodiment, the counselor device 104 may perform follow-up responses to the user's query using the data determined by the first LLM, and may transmit information on the reaction to the follow-up responses to the server 101.

According to an embodiment, the server 101 may input at least one among the input text data of the user's query, user's intent information, context information, guide information, and reaction information into the second LLM to generate answer text data to be transmitted to the user device 100.

According to an embodiment, the server 101 may transmit the generated answer text data to the user device 100 or may convert the answer text data into voice data using a Text to Speech (TTS) technique and transmit the voice data to the user device 100.

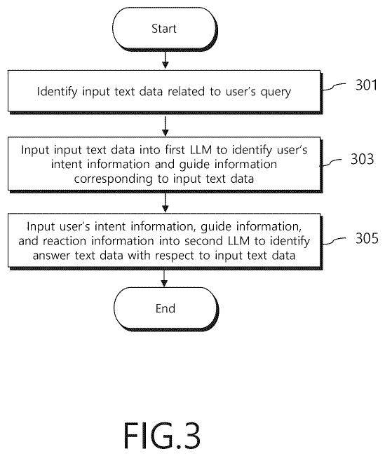

FIG. 3 is a flowchart illustrating an operation of generating answer text data with respect to a user's query using an LLM by the server (e.g., the server 101 of FIG. 1) according to various embodiments.

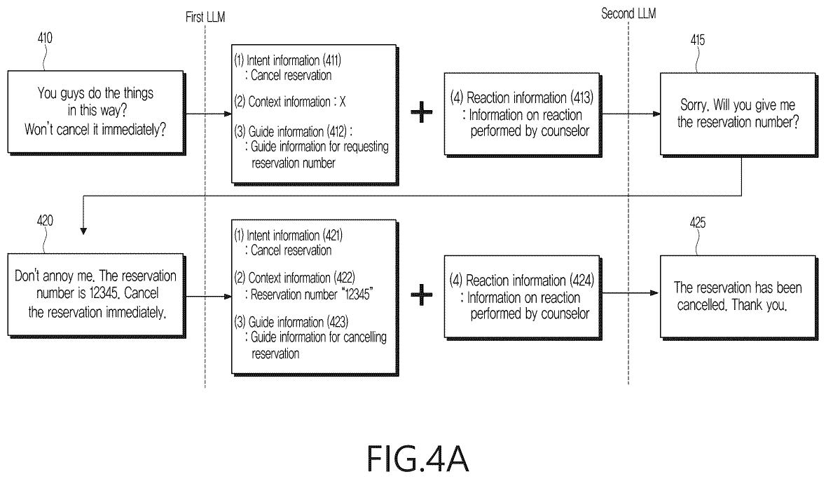

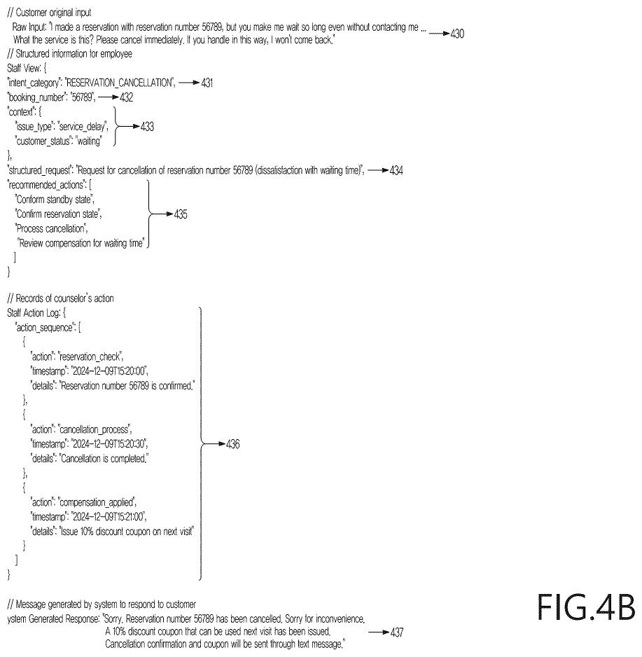

FIG. 4A is a view showing a first embodiment of generating answer text data with respect to a user's query by the server 101 using a first LLM and a second LLM according to various embodiments.

FIG. 4B is a view showing a second embodiment of generating answer text data with respect to a user's query by the server 101 using a first LLM and a second LLM according to various embodiments.

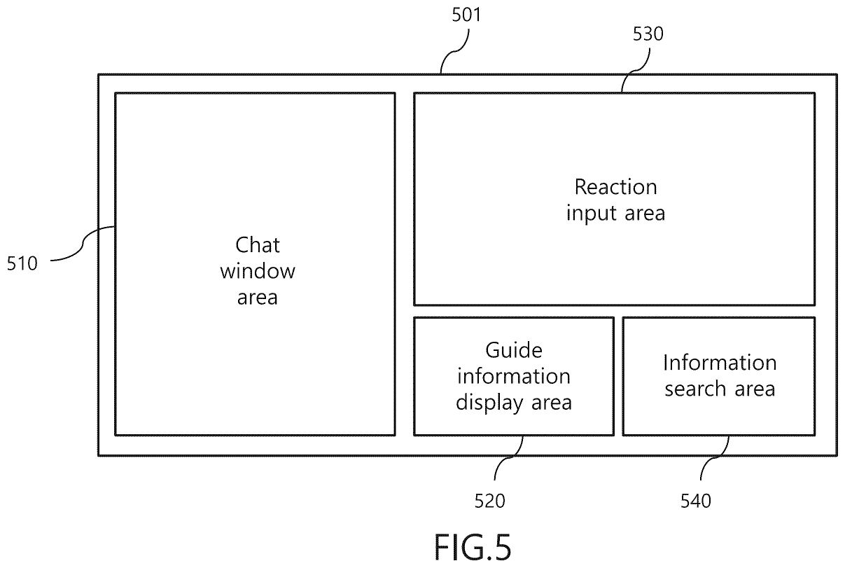

FIG. 5 is a view showing the configuration of a screen used when a counselor device (e.g., the counselor device 104 of FIG. 1) performs counseling using a user device (e.g., the user device 100 of FIG. 1) and a counseling assistance service according to various embodiments.

In operation 301, according to various embodiments, the server 101 (e.g., the processor 121 of FIG. 1) may identify input text data related to a user's query.

According to various embodiments, the server 101 (e.g., the processor 121 of FIG. 1) may receive voice data (e.g., user's speech) related to the user's query from the user device 100 through a communication module (e.g., the communication module 111 of FIG. 1), and convert the received voice data into input text data. For example, referring to FIG. 4A, the user device 100 may acquire user's first voice data (e.g., “You guys do the things in this way? Won't cancel it immediately?”) through a microphone module provided therein and transmit the first voice data to the server 101, and the server 101 may convert the user's voice data into first input text data 410 of text form. As another example, referring to FIG. 4A, the user device 100 may acquire user's second voice data (e.g., “Don't annoy me. The reservation number is 12345. Cancel the reservation immediately”) through a microphone module provided therein and transmit the second voice data to the server 101, and the server 101 may convert the user's voice data into second input text data 420 of text form. As still another example, referring to FIG. 4B, the user device 100 may acquire user's first voice data (e.g., “I made a reservation with the reservation number 56789, but you make me wait so long without even contacting me. What kind of service is this? Cancel it immediately. I will not come back if you do the things in this way!”) through a microphone module and transmit the first voice data to the server 101, and the server 101 may convert the user's voice data into input text data 430 of text form. According to an embodiment, the server 101 may convert the voice data received from the user device 100 into text data using a Speech-to-Text (STT) module.

According to various embodiments, the server 101 (e.g., the processor 121 of FIG. 1) may receive input text data related to the user's query from the user device 100 through the communication module 111. For example, the server 101 may receive a text message input by the user from the user device 100 as input text data.

In operation 303, according to various embodiments, the server 101 (e.g., the processor 121 of FIG. 1) may input the input text data related to the user's query into a first Large Language Model (LLM) to identify user's intent information and guide information corresponding to the input text data.

According to various embodiments, the server 101 (e.g., the processor 121 of FIG. 1) may input the input text data related to the user's query into the first Large Language Model (LLM). According to an embodiment, the first LLM may be stored in the memory of the server 101 (e.g., the memory 131 of FIG. 1) or may be stored in a separate external server other than the server 101 and linked to the server 101.

According to various embodiments, when the input text data related to the user's query is input into the first LLM, the server 101 (e.g., the processor 121 of FIG. 1) may identify structured first information for employee (counselor) output from the first LLM. According to an embodiment, the first information may be configured of at least one among the user's intent information, numeric information corresponding to the user's intent information, context information corresponding to the user's intent information, structured request information, and guide information.

According to various embodiments, the server 101 (e.g., the processor 121 of FIG. 1) may input the input text data related to the user's query into the first LLM and identify user's intent information corresponding to the input text data determined by the first LLM.

According to an embodiment, the user's intent information may indicate the intent of the user's query, and the user's intent information may have a structured format. According to an embodiment, the user's intent information may be classified into one of a plurality of categories. For example, referring to FIG. 4A, the server 101 may input the first input text data 410 into the first LLM, and identify first user's intent information 411 (e.g., reservation cancellation) corresponding to the first input text data 410 among a plurality of predetermined categories. As another example, referring to FIG. 4B, the server 101 may identify “RESERVATION_CANCELLATION” as user's intent information 431 (e.g., intent_category) output from the first LLM and corresponding to the input text data 430. The plurality of categories of the user's intent information may be set by the manager of the server 101 or may be set by the first LLM during the learning process of the first LLM.

According to an embodiment, the server 101 may identify user's intent information from the input text data related to the user's query on the basis of a natural language understanding (NLU) module, instead of using the first LLM. For example, the NLU module may grasp user's intent information by performing syntactic analysis or semantic analysis. According to an embodiment, the NLU module may grasp the meaning of words extracted from the input text data using linguistic features (e.g., syntactic elements) of morphemes or phrases, and determine user's intent information by matching the grasped meaning of words to the intent. The syntactic analysis may divide the input text data into syntactic units (e.g., words, phrases, morphemes, etc.), and grasp syntactic elements that the divided units have. The semantic analysis may be performed using semantic matching, rule matching, formula matching, or the like. In an embodiment, the NLU module may determine user's intent information using a natural language recognition database that stores linguistic features for grasping the intent of the input text data. According to another embodiment, the NLU module may determine the user's intent information using a personal language model (PLM) stored in the natural language recognition database.

According to various embodiments, the server 101 (e.g., the processor 121 of FIG. 1) may input the input text data related to the user's query into the first LLM to identify at least one among numeric information, context information, and request information corresponding to the user's intent information, together with the user's intent information, from the input text data.

According to an embodiment, the context information is information needed to resolve the user's intent information, and may indicate information that should be set to perform the user's intent information. For example, referring to FIG. 4A, the server 101 may input the second input text data 420 into the first LLM to identify second user's intent information 421 (e.g., reservation cancellation) and second context information 422 (e.g., reservation number “12345”) corresponding to the second input text data 420 among a plurality of predetermined categories.

According to an embodiment, the numeric information is numeric information associated with the user's intent information and may indicate information recognized as a number within the input text data. According to an embodiment, the numeric information may be configured of information separate from the context information or may be configured of one type of context information, and may be classified into at least one category. For example, referring to FIG. 4B, the server 101 may identify “56789” corresponding to a reservation number as numeric information 432 (e.g., booking_number) output from the first LLM and corresponding to the input text data 430. The format of the numeric information is not limited to the example described above, and the numeric information may be implemented in various formats.

According to an embodiment, the context information may include at least one among issue type information and customer state information. For example, referring to FIG. 4B, the server 101 may input the input text data 430 into the first LLM to identify context information 433 including “service_delay” as the issue type information (e.g., issue_type) and “waiting” as the customer state information (e.g., customer_status) together with the user's intent information 431. The format of the context information is not limited to the example described above, and the context information may be implemented in various formats.

According to an embodiment, as well as being identified by the first LLM, the context information may be mapped to the input text data and stored in the memory 131 of the server 101 in advance as a predetermined rule (e.g., situational internal response guideline).

According to an embodiment, the request information may be information combined with at least one among the user's intent information, numeric information, and context information, and indicate information summarizing the input text data by the first LLM, and may be information that will be shown to the counselor of the counselor device 104. For example, referring to FIG. 4B, the server 101 may input the input text data 430 into the first LLM to identify “request for cancellation of reservation number 56789 (dissatisfaction with waiting time)” as request information 434 (e.g., structured_request), together with the user's intent information 431. The format of the request information is not limited to the example described above, and the request information may be implemented in various formats.

In an embodiment, the numeric information or request information described above may be implemented as a part of the context information.

According to various embodiments, the server 101 (e.g., the processor 121 of FIG. 1) may input the input text data related to the user's query into the first LLM to identify guide information corresponding to the input text data.

According to an embodiment, the guide information may indicate guide information for a counselor to perform follow-up responses in response to the user's intent information, or indicate guide information for requesting context information needed to perform the follow-up responses. Specifically, the guide information may be configured of a series of information related to data input (e.g., screen recording information, mouse click information, text input information, audio input information, and the like over time). For example, referring to FIG. 4A, the server 101 may input first input text data 410 into the first LLM, identify first user's intent information 411 (e.g., reservation cancellation) corresponding to the first input text data 410 among a plurality of predetermined categories, and identify guide information 412 for requesting context information that needs confirmation (e.g., guide information for requesting a reservation number) when context information corresponding to the intent information 411 is not confirmed. As another example, referring to FIG. 4A, the server 101 may input second input text data 420 into the first LLM, identify second user's intent information 421 (e.g., reservation cancellation) and context information 422 (e.g., reservation number “12345”) corresponding to the second input text data 420 among a plurality of predetermined categories, and identify guide information 423 (e.g., guide information for reservation cancellation) for performing follow-up responses.

According to an embodiment, the guide information may indicate a series of sequential action information for a counselor to perform follow-up responses in response to the user's intent information. For example, referring to FIG. 4B, when the server 101 inputs the input text data 430 into the first LLM, the server 101 may identify a series of action information for “confirm waiting situation”, “confirm reservation state”, “process cancellation”, and “review compensation for waiting time” as guide information 435 (e.g., recommended_actions) corresponding to the input text data 430. In this case, each guide information may have a link (URL) format or may be configured in various formats to realize a corresponding action. The format of the guide information is not limited to the example described above, and the guide information may be implemented in various formats.

According to various embodiments, the server 101 (e.g., the processor 121 of FIG. 1) may train the first LLM using at least one among a plurality of input text data, a plurality of user's intent information, a plurality of context information, and a plurality of reaction information.

In an embodiment, the reaction information may be information on the reaction to follow-up responses performed by the counselor in response to the input text data, or may indicate reaction information for requesting context information needed for performing the follow-up responses. Specifically, the reaction information may be configured of at least one among a series of action information of actions performed by the counselor (e.g., screen recording information, mouse click information, audio input information, and the like over time) and answer text data generated after the series of action information. According to an embodiment, the reaction information may be structured according to a predetermined format. For example, referring to FIG. 5, the server 101 may structure and classify, by the types, messages (e.g., SMS, E-mail, etc.) transmitted and received between the user device 100 and the counselor device 104 through a chat window area in the display 501 of the counselor device (e.g., the electronic device 104 of FIG. 1), commands (e.g., a series of action information for reservation, a series of action information for reservation cancellation, etc.) input by the counselor through a reaction input area 530 in the display 501, voice data (e.g., VoIP call, etc.) transmitted and received between the counselor device 104 and the user device 100, information (e.g., internal instructions, external server access, details of user's reservation, pattern of user's purchase) inquired by the counselor through an information search area 540 in the display 501, and the like.

According to an embodiment, the structure and/or format of the reaction information may be the same as or different from the structure and/or format of the guide information, and for example, the structure and/or format may be the same as or different from the reaction information according to whether the guide information includes answer text data that will be recommended to the counselor. In addition, the first LLM may learn the correlation between (1) a plurality of input text data and (2) at least one among a plurality of user's intent information, a plurality of context information, and a plurality of reaction information. According to an embodiment, the server 101 may perform the learning process of the first LLM by optimizing the weights in a way of acquiring a result value (output data) using the first LLM to which arbitrary weights are assigned, comparing the acquired result value with labeled data or unlabeled data of the learning data, and performing backpropagation according to the error. Specifically, learning of the first LLM means a process of training the first LLM based on the learning data and labeled data or unlabeled data to allow the first LLM to determine output data for the input data. That is, the first LLM makes a determination by forming a rule for the data.

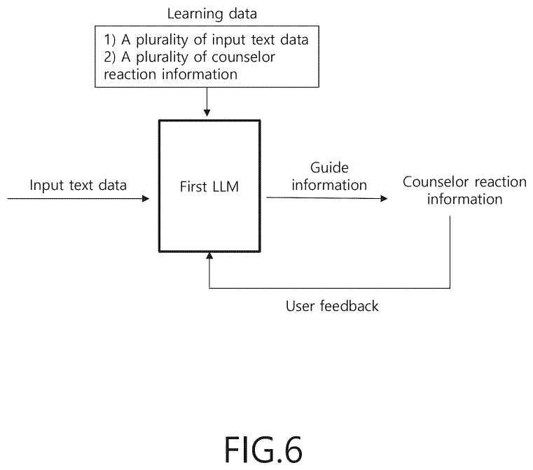

According to an embodiment, the first LLM may be trained to output at least one among the user's intent information, context information, and guide information when input text data is input. For example, the first LLM may be trained to output user's intent information when input text data is input. In another example, the first LLM may be trained to output user's intent information and context information associated with the user's intent information when input text data is input. In another example, the first LLM may be trained to output guide information corresponding to input text data when the input text data is input. The specific operation of outputting the guide information will be described below in detail with reference to FIG. 6.

According to an embodiment, the server 101 may input the input text data into one LLM and identify at least one among the user's intent information, context information, and guide information, or input the input text data into the first LLM configured of at least two sub-models, collect data output from each sub-model, and identify at least one among the user's intent information, context information, and guide information. For example, the first LLM may be implemented as a combination of at least one among a sub-classification model for classifying user's intent information from the input text data, a sub-extraction model for extracting context information, and a sub-creation model for generating guide information, and the implementation form of the first LLM is not limited to the example described above and may be implemented as a combination of various sub-modular artificial intelligence models to individually optimize performance for identifying each information.

According to an embodiment, the LLMs described in the present disclosure may generate output data using data related to details of previous conversation until the conversation session is terminated.

In operation 305, according to various embodiments, the server 101 (e.g., the processor 121 of FIG. 1) may input the user's intent information, guide information, and information on the reaction to the guide information into the second LLM to identify answer text data with respect to the input text data.

In an embodiment, referring to FIG. 4A, the server 101 may receive, from the counselor device 104, first reaction information 413 (e.g., a series of action information for requesting a reservation number) performed by the counselor in response to the first input text data 410. As another example, referring to FIG. 4A, the server 101 may receive, from the counselor device 104, second reaction information 424 (e.g., a series of action information for canceling a reservation) of a reaction performed by the counselor in response to the second input text data 420.

According to an embodiment, the format of the reaction information may be implemented as a series of information related to confirmation or input of data (e.g., screen display information, mouse click information, text input information, audio input information, and the like over time). According to an embodiment, the reaction information may include log information related to the operation of the counselor device 104 performed by the counselor, and the log information may include at least one among action information, time information, and result information. For example, referring to FIG. 4B, the server 101 may receive (i) first reaction information including first action information (e.g., “reservation_check”), first time information (e.g., “2024-12-09T15:20:00”), and first result information (e.g., “confirmation of reservation number 56789 is completed”), (ii) second reaction information including second action information (e.g., “cancellation_process”), second time information (e.g., “2024-12-09T15:20:30”), and second result information (e.g., “cancellation process is completed”), and (iii) third reaction information including third action information (e.g., “compensation_applied”), third time information (e.g., “2024-12-09T15:21:00”), and third result information (e.g., “Issue a 10% discount coupon on next visit”) from the counselor device 104 as a series of reaction information 436 of reactions performed by the counselor in response to the input text data 430.

According to an embodiment, referring to FIG. 5, the counselor may input reaction information through the reaction input area 530 with reference to the guide information displayed through the guide information display area 520 in the display 501 of the counselor device 104. According to an embodiment, the counselor device 104 may display the guide information 435 as text through the guide information display area 520 or as other forms of information based on the text (e.g., recorded screen display, mouse click/text input guide, voice message output, etc.).

According to various embodiments, the server 101 (e.g., the processor 121 of FIG. 1) may input user's intent information and guide information corresponding to the input text data and information on the reaction to the guide information into the second Large Language Model (LLM). According to an embodiment, the second LLM may be stored in the memory 131 of the server 101, or may be stored in a separate external server other than the inside of the server 101 and linked to the server 101.

According to various embodiments, the server 101 (e.g., the processor 121 of FIG. 1) may input at least one among input text data, user's intent information, numeric information, context information, request information, guide information, and information on the reaction to the guide information into the second LLM, and identify answer text data with respect to the input text data determined by the second LLM. For example, referring to FIG. 4A, the server 101 may input the first input text data 410, first user's intent information 411, first guide information 412, and first reaction information 413 into the second LLM, and identify first answer text data 415 with respect to the first input text data 410 output from the second LLM. As another example, referring to FIG. 4A, the server 101 may input the second input text data 420, second user's intent information 421, context information 422, second guide information 423, and second reaction information 424 into the second LLM, and identify second answer text data 425 with respect to the second input text data 420 output from the second LLM. As another example, referring to FIG. 4B, the server 101 may input at least one among the input text data 430, user's intent information 431, numeric information 432, context information 433, request information 434, guide information 435, and reaction information 436 into the second LLM, and identify answer text data 437 with respect to the input text data 430 output from the second LLM.

According to various embodiments, the server 101 (e.g., the processor 121 of FIG. 1) may train the second LLM using at least one among a plurality of input text data, a plurality of user's intent information, a plurality of context information, a plurality of guide information, and a plurality of reaction information. The plurality of reaction information used for training the second LLM may include both a series of action information of a plurality of counselors and answer text data of a plurality of counselors.

According to an embodiment, the second LLM may learn the correlation between (1) at least one among a plurality of input text data, a plurality of user's intent information, a plurality of context information, a plurality of guide information, and a series of action information of a plurality of counselors and (2) answer text data of a plurality of counselors. According to an embodiment, the server 101 may perform the learning process of the second LLM by optimizing the weights in a way of acquiring a result value (output data) using the second LLM to which arbitrary weights are assigned, comparing the acquired result value with labeled data or unlabeled data of the learning data, and performing backpropagation according to the error. Specifically, learning of the second LLM means a process of training the second LLM based on the learning data and labeled data or unlabeled data to allow the second LLM to determine output data for the input data. That is, the second LLM makes a determination by forming a rule for the data.

According to an embodiment, the second LLM may be trained to output answer text data with respect to the input text data when at least one among the input text data, user's intent information, context information, guide information, and a series of action information of a counselor is input.

FIG. 6 is an exemplary view showing a method of operating a first LLM trained to output guide information according to various embodiments.

According to various embodiments, the server (e.g., the server 101 of FIG. 1) may train the first LLM to output guide information corresponding to input text data when input text data is input. According to an embodiment, the first LLM may be trained to output guide information corresponding to input text data when at least one among the user's intent information corresponding to the input text data and context information associated with the user's intent information is input together with the input text data.

According to various embodiments, the first LLM may learn the correlation between (1) a plurality of input text data and (2) a plurality of counselor reaction information. According to an embodiment, the server 101 may perform the learning process of the first LLM by optimizing the weights in a way of acquiring a result value (output data) using the first LLM to which arbitrary weights are assigned, comparing the acquired result value with labeled data or unlabeled data of the learning data, and performing backpropagation according to the error. Specifically, learning of the first LLM means a process of training the first LLM based on the learning data and labeled data or unlabeled data to allow the first LLM to determine output data for the input data. That is, the first LLM makes a determination by forming a rule for the data.

According to various embodiments, the first LLM may output guide information corresponding to the input text data, collect feedback of a user device (e.g., the user device 100 of FIG. 1) about the information on the reaction performed by the counselor, and reflect data quality related to the reaction information. In this process, the server 101 may utilize various algorithms (e.g., loss function, gradient descent, normalization technique, etc.) to optimize the first LLM. Specifically, the data quality of the reaction information may be determined according to the weight of user feedback received from the user device 100 and reflected in the learning data of the first LLM.

The server 101 according to an embodiment may classify the feedback received from the user device 100 by type, and differentially assign weights according to predefined criteria based on the reliability and importance of each type. According to an embodiment, the server 101 may assign a relatively high absolute value weight to explicit feedback, in which the user directly expresses their intention. For example, the server 101 may differentially assign weights based on a specific satisfaction level selected by the user from a plurality of preset choices, a binary response such as whether a problem was resolved, or the sentiment analysis result of text directly input by the user.

According to another embodiment, the server 101 may assign a relatively low absolute value weight to implicit feedback, which is indirect information that can be inferred from the user's behavior patterns, compared to explicit feedback. For example, the server 101 may assign weights according to the result calculated by analyzing the user's behavior, such as the conversation termination pattern after the counselor's response, whether the same or similar queries are repeated, or whether the task guided by the counselor was actually performed.

As described above, the server 101 may determine the final data quality of the reaction information by aggregating the weights calculated from various types of feedback, and continuously optimize the system performance by reflecting this in the learning process of the first LLM.

According to various embodiments, a server for analyzing a user's query and assisting counseling service of a counselor using an LLM includes a communication module and a processor. The processor may be configured to identify input text data related to the user's query, input the input text data into a first Large Language Model (LLM) to identify user's intent information and guide information corresponding to the input text data, and input the user's intent information, the guide information, and information on a reaction to the guide information into a second LLM to identify answer text data with respect to the input text data, wherein the first LLM is trained based on a plurality of input text data, a plurality of user's intent information, and a plurality of reaction information, and the second LLM is trained based on one or more input text data, one or more user's intent information, one or more guide information, one or more reaction information, and one or more answer text data.

According to various embodiments, the processor may be set to input the input text data into the first LLM to identify context information, together with the user's intent information, from the input text data.

According to various embodiments, the processor may be set to input the input text data into the first LLM, identify the user's intent information corresponding to the input text data among a plurality of predetermined categories, and identify guide information for requesting the context information when the context information corresponding to the user's intent information is not identified.

According to various embodiments, the reaction information is configured of a series of action information of actions performed by a counselor device in response to the user's query, and answer text data input by the counselor device after the series of action information.

According to various embodiments, the processor may be set to input the input text data, the user's intent information, the context information, the guide information, and the reaction information into the second LLM to identify the answer text data with respect to the input text data.

According to various embodiments, an operation method of a server for analyzing a user's query and assisting counseling service of a counselor using an LLM includes: an operation of identifying input text data related to the user's query; an operation of inputting the input text data into a first Large Language Model (LLM) to identify user's intent information and guide information corresponding to the input text data; and an operation of inputting the user's intent information, the guide information, and information on a reaction to the guide information into a second LLM to identify answer text data with respect to the input text data, wherein the first LLM is trained based on a plurality of input text data, a plurality of user's intent information, and a plurality of reaction information, and the second LLM is trained based on one or more input text data, one or more user's intent information, one or more guide information, one or more reaction information, and one or more answer text data.

According to various embodiments, the operation of identifying the user's intent information and the guide information includes an operation of inputting the input text data into the first LLM to identify context information, together with the user's intent information, from the input text data.

The term “module” or “˜ unit” used in this document includes a unit configured of hardware, software, or firmware, and may be used interchangeably with terms, for example, logic, logic block, part, and circuit. The “module” or “˜ unit” may be an integrally configured component, or a minimum unit or a part thereof that performs one or more functions. The “module” or “˜unit” may be implemented mechanically or electronically, and include, for example, an application-specific integrated circuit (ASIC) chip, field-programmable gate arrays (FPGAs), or a programmable logic device known or to be developed in the future to perform certain operations, and may be executed by the processor 120. At least some of devices (e.g., modules or functions thereof) or methods (e.g., operations) according to various embodiments may be implemented as instructions stored in a computer-readable storage medium (e.g., the memory 130) in the form of a program module. When the instructions are executed by a processor (e.g., the processor 120), the processor may perform a function corresponding to the instructions. The computer-readable recording medium may include a hard disk, a floppy disk, a magnetic medium (e.g., a magnetic tape), an optical recording medium (e.g., a CD-ROM, a DVD), a magneto-optical medium (e.g., a floptical disk), a built-in memory, and the like. The instructions may include codes generated by a compiler or codes executable by an interpreter. A module or a program module according to various embodiments may include at least one or more of the components described above, omit some of the components, or further include other components. Operations performed by a module, a program module, or other components according to various embodiments may be executed sequentially, in parallel, repeatedly, or heuristically, or at least some of the operations may be executed in a different order or omitted, or other operations may be added.

In addition, the embodiments disclosed in this document are presented for the purpose of explanation and understanding of the disclosed technical contents, and do not limit the scope of the present disclosure. Accordingly, the scope of the present disclosure should be interpreted to include all modifications or various other embodiments based on the technical spirit of the present disclosure.

What is claimed is:

1. A server for analyzing a user's query and assisting counseling service of a counselor using an LLM, the server comprising:
a communication module; and
a processor, wherein
the processor is set to
identify input text data related to the user's query,
input the input text data into a first Large Language Model (LLM) to identify user's intent information and guide information corresponding to the input text data, and
input the user's intent information, the guide information, and information on a reaction to the guide information into a second LLM to identify answer text data with respect to the input text data, wherein
the first LLM is trained based on a plurality of input text data, a plurality of user's intent information, and a plurality of reaction information, and
the second LLM is trained based on one or more input text data, one or more user's intent information, one or more guide information, one or more reaction information, and one or more answer text data.

2. The server according to claim 1, wherein the processor is set to input the input text data into the first LLM to identify context information, together with the user's intent information, from the input text data.

3. The server according to claim 2, wherein the processor is set to input the input text data into the first LLM, identify the user's intent information corresponding to the input text data among a plurality of predetermined categories, and identify guide information for requesting the context information when the context information corresponding to the user's intent information is not identified.

4. The server according to claim 3, wherein the reaction information is configured of a series of action information of actions performed by a counselor device in response to the user's query, and answer text data input by the counselor device after the series of action information.

5. The server according to claim 2, wherein the processor is set to input the input text data, the user's intent information, the context information, the guide information, and the reaction information into the second LLM to identify the answer text data with respect to the input text data.

6. An operation method of a server for analyzing a user's query and assisting counseling service of a counselor using an LLM, the method comprising:
an operation of identifying input text data related to the user's query;
an operation of inputting the input text data into a first Large Language Model (LLM) to identify user's intent information and guide information corresponding to the input text data; and
an operation of inputting the user's intent information, the guide information, and information on a reaction to the guide information into a second LLM to identify answer text data with respect to the input text data, wherein
the first LLM is trained based on a plurality of input text data, a plurality of user's intent information, and a plurality of reaction information, and
the second LLM is trained based on one or more input text data, one or more user's intent information, one or more guide information, one or more reaction information, and one or more answer text data.

7. The method according to claim 6, wherein the operation of identifying the user's intent information and the guide information includes an operation of inputting the input text data into the first LLM to identify context information, together with the user's intent information, from the input text data.
